(19) United States
(12) Patent Application Publication
(10) Pub. No.: US 2007/0082623 A1
(43) Pub. Date: Apr. 12, 2007

(54) Mimo transmitter and receiver for low-scattering environments

(75) Inventors: Paul Mattheijssen, Eindhoven (NL); Maurice Raymond Borman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 10/576,311

(22) PCT Filed: Oct. 12, 2004
(86) PCT No.: PCT/IB04/52063

§ 371 Date: Apr. 18, 2006

(30) Foreign Application Priority Data
Oct. 21, 2003 (EP) 03103889.6

(51) Int. Cl. H04B 1/02

(52) U.S. Cl. 455/101

(57) ABSTRACT

A transmitter (Tx1, Tx2) is arranged for simultaneously transmitting at least a first (s′₁) and a second (S′₂) signal. The first signal (s′₁) is modulated according to a first modulation constellation and the second signal (s′₂) is modulated according to a second modulation constellation. The transmitter is arranged to pre-code at least the first signal (s′₁) through a modification of the first modulation constellation so as to prevent a correlation between the at least first (s′₁) and second (s′₂) simultaneously transmitted signals.

The invention relates to a transmitter that is arranged to simultaneously transmit at least a first and a second signal. The invention further relates to a receiver that is arranged to simultaneously receive a first and a second signal. In addition, the invention relates to a transceiver, a wireless device and a telecommunication system comprising such a transmitter.

The invention finds its application in wireless telecommunication or data communication systems or devices that make use of Multiple Input Multiple Output (MIMO) technology. The invention is particularly suited for telecommunication or data communication systems that require higher order modulation schemes and where the transmission medium has a random nature. Examples are Bluetooth devices, Wireless LAN devices and wireless devices such as mobile phones or personal digital assistants.

Such a telecommunication system is disclosed in the U.S. patent application Ser. No. 2002/0181509A1. Shown is a Multiple Input Multiple Output telecommunication system having a transmitter that encodes the data that is coming from a data source into several parallel data streams that are subsequently transmitted across a radio channel by means of a number of transmit antennas. In addition, the telecommunication system comprises a receiver having a number of receive antennas for receiving the multiple data streams. The receiver further comprises a decoder for merging the-multiple data streams into a single (digital) data stream. Although, such MIMO systems generally perform well in a rich-scattering environment they are prone to failure in a low-scattering environment.

It is an object of the present invention to provide transmitter that will improve the performance of a MIMO system in low-scattering environments. To this end, the transmitter for simultaneously transmitting at least a first and a second signal, the first signal being modulated according to a first modulation constellation, the second signal being modulated according to a second modulation constellation, wherein the transmitter is arranged to pre-code at least the first signal through a modification of the first modulation constellation so as to prevent a correlation between the at least first and second simultaneously transmitted signals.

The invention is based upon the insight that MIMO systems generally work well in rich scattering environments such as in a non-line-of sight scenario wherein the communication channel assures orthogonality of the transmitted signals. In low scattering environments however, such as line-of-sight scenario's, the orthogonality among the encoded data streams might be entirely lost. Or in other words, the data streams can become correlated. Consequently, the receiver will not be able to distinguish between the simultaneously transmitted data streams so that detection of the transmitted signal may partially fail. The invention is further based upon the insight that from a system point of view, it is of no importance whether the orthogonality of the parallel streams is provided by the behavior of the communication channels or by the transmitter itself. Therefore, by pre-coding the baseband signals, it is the transmitter that provides orthogonality rather than the communication channels. This provides the advantage that the MIMO system can remain operational even under unfavorable propagating conditions.

In an embodiment of the transmitter according to the present invention, the pre-coding of at least the first signal comprises a rotation of the first modulation constellation through a first angle. Each one of the at least two simultaneously transmitted signals is encoded according to a modulation constellation i.e. bits are being mapped onto symbols. At the receiver side, these two modulation constellations merge into a single (de)modulation constellation having an order that is equal to the sum of the order of first and second modulation constellations. During unfavorable transmission conditions however, the transmitted signals become correlated. Consequently, the (de)modulation constellation at the receiver shows overlapping points. Therefore order of the (de)modulation constellation is impaired so that the receiver might no longer be able to successfully demodulate the simultaneously transmitted signals. By rotating at least one of the modulation constellations, it is the transmitter that provides the required orthogonality between the at least two simultaneously transmitted signals and not the channel. Consequently, the modulation constellations of the at least two transmitted signals merge into a single (de)modulation constellation having non-overlapping points. Through this, a successful demodulation of the at least two simultaneously transmitted signals, even under poor propagating conditions, can be assured.

In yet another embodiment of the receiver according to the present invention, the pre-coding of at least the first signal comprises a change of the order of the first modulation constellation. Under poor receiving conditions is may not be possible to sustain a certain data rate. In such a situation, the transmitter may consider to lower the order of the modulation constellation of at least the first signal to reduce the achievable bit rate of at least the first signal. However, once the propagation conditions improve, the order of the modulation of the modulation constellation may be again increased.

In still another embodiment of a transmitter according to the present invention, the pre-coding further comprises a change of the number of simultaneously transmitted signals. The modulation constellations are used to map a bit stream into symbols therefore, a modification of the order of a modulation constellation will have consequences for the maximum achievable bit rate. A reduction of the order of the modulation constellation for example, will therefore automatically cause a reduction of the maximum achievable bit rate whilst an increment of the order causes an increment of the maximum achievable bit rate. As will be apparent to those skilled in the art, a MIMO transmitter is arranged to encode a single data stream into several (parallel) data streams which, are simultaneously transmitted. In principle, the number of (parallel) data streams and thus the number of simultaneously transmitted signals can be made dependent on the required bit rate. Therefore, modifying the number of transmitted signals can counteract the effect of modifying the order of the modulation constellations. For example, a reduction of the order of at least one constellation diagram can be counteracted by increasing the number of transmitted signal and of course vice-versa.

In another embodiment of the transmitter according to the present invention, the transmitter is arranged to pre-code at least the first signal after receipt of a first signal from a receiver of the at least first and second simultaneously transmitted signals. It will be understood by those skilled in the art that only the receiver can determine whether the simultaneously transmitted signals remained uncorrelated. By transmitting the first signal to the transmitter, the receiver informs the transmitter about the quality of the received signals. The signal may for example, comprise an instruction to the transmitter to pre-code at least one of the transmitted signals or it may a suitable quality indicator such as a bit error rate (BER). The first signal may be an independently transmitted (aired) signal or it may be incorporated into an (existing) communication protocol that is in use to establish and maintain the communication link between the transmitter and the receiver.

In an embodiment of the transmitter according to the present invention, the transmitter is arranged to transmit a second signal to a receiver of the at least first and second simultaneously transmitted signals so as to notify the receiver about the pre-coding of at least the first of the at least two signals. It will be understood by those skilled in the art, that a receiver cannot autonomously decode a pre-coded signal unless the receiver is informed about the details of the preceding. Alternatively, the second signal may for example, comprise an acknowledge to the receipt of the first signal The second signal may be an independently transmitted (aired) signal or alternatively, it may be incorporated into an (existing) communication protocol that is required to establish and maintain the communication link between the transmitter and the receiver. It will be apparent to those skilled in the art that the format of the messages that are comprised in the first and second signals will largely depend on the intelligence built into the transmitter and the receiver.

These and other aspects according to the present invention will be elucidated by means of the following drawings.

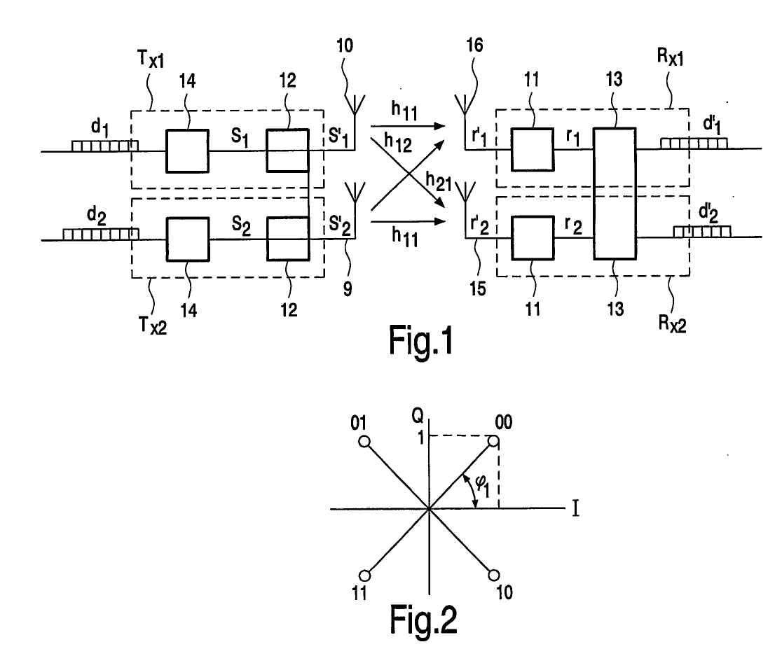

FIG. 1, shows a Multiple Input Multiple Output telecommunication system according to the prior art.

FIG. 2, shows a prior art QPSK modulation constellations.

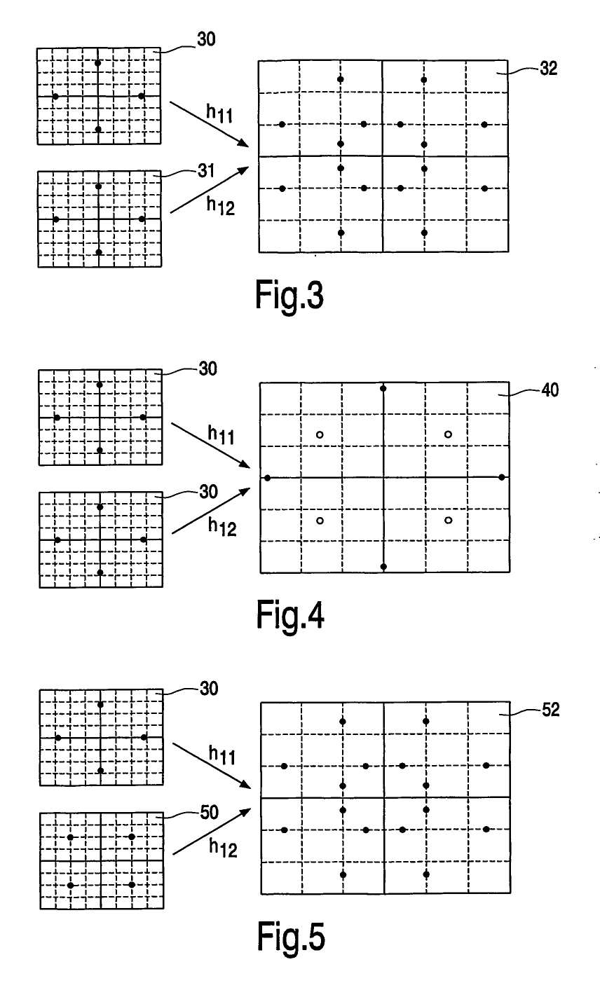

FIG. 3, shows prior art modulation constellations of a MIMO system art.

FIG. 4, shows prior art modulation constellations of a MIMO system having correlated the communication channels.

FIG. 5, shows modulation constellations according to the invention wherein at least one constellation is rotated through an angle.

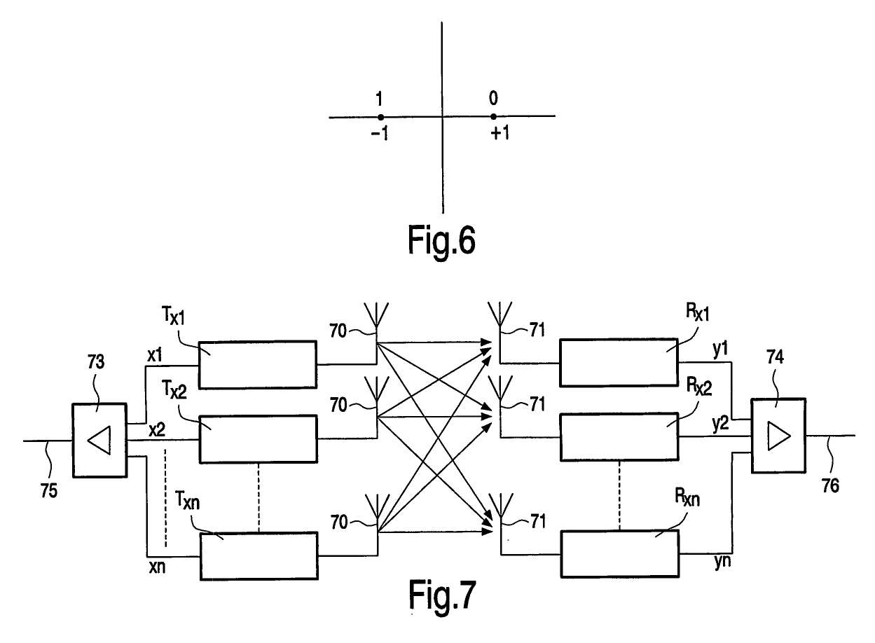

FIG. 6, shows a BPSK modulation constellation.

FIG. 7, shows a telecommunication system according to the present invention.

FIG. 1, shows a 2×2 Multiple Input Multiple Output telecommunication system according to the prior art. The telecommunication system comprises signal-processing means 14 for mapping bit streams d1 and d2 into symbols using so-called modulation constellations. An example of a QPSK constellation is shown in FIG. 2. Using QPSK, bits are pair wise mapped onto symbols according to the following set of rules:
00→(1+j)/√2 or exp(jφ₁)
01→(−1+j)/√2 or exp(jφ₂)
11→(−1−j)/√2 or exp(jφ₃)
10→(1−j)/√2 or exp(jφ₄)

Each symbol can therefore be expressed as a (normalized) vector in the I-Q plane or as exp(jφₓ). By means of the mapping operation, bitstreams d1,d2 are converted into signals s₁ and s₂. Each signal s₁, s₂ is modulated into signals s′₁ and S′₂ by means of RF section 12 and subsequently transmitted to the receiving side of the system. Due to the behavior or the communications channel(s) between the transmitters Tₓ₁,Tₓ₂ and receivers Rₓ₁,Rₓ₂, signals s′₁ and S′₂ are received as r′₁ and r′₂. Each receivers Rₓ₁,Rₓ₂ comprises an RF section 11 for demodulating the signals r′₁,r′₂ into r₁, r₂ The relation between the transmitted signals S=(s₁,S₂) and the received signals R=(r₁, r₂) is given by R=H.S wherein H=(h₁₁,h₁₂;h₂₁,h₂₂)is usually referred to as the transfer matrix. The coefficients hᵢⱼ of transfer matrix H define the behavior of the communication channels between the transmitters and the receivers. Coefficient hi for example relates to the communication channel between antennas 10 and 16 whereas h₁₂ relates to the channel between antennas 10 and 15. Consequently, signals r₁, r₂ can be expressed as r₁=h₁₁.s₁+h₁₂.s₂ and r₂=h₂₁.s₁+h₂₂.s₂. Since H can easily be derived by those skilled in the art, the signal processing means 13 of the receivers can easily make an estimate of the transmitted signals using the relation S=R.H¹. For reasons of simplicity, the effect of added noise that would result in the addition of a noise vector to the received signals R has been disregarded. Once the transmitted signals have been estimated at the receiving end, they are de-mapped to convert the symbols of the estimated transmitted signals r₁, r₂ into bit streams d′₁ and d′₂. During proper working conditions, bit streams d′₁ and d′₂ correspond to the originally transmitted bit streams d₁ and d₂. As will be apparent to those skilled in the art, it will only be possible to retrieve the transmitted signals if the transfer matrix can be inverted i.e. DET(H)< >0. Those skilled in the art, will recognize in the mathematical requirement DET(H)< >0 the precondition that the communication channels between the transmitters Tₓ₁,Tₓ₂ and the receivers Rₓ₁,Rₓ₂ must remain un-correlated, or in other words, the transmitted signals s₁ and S₂ must remain orthogonal during propagation. It is well known that MIMO systems work well in rich scattering environments, but may fail in e.g. line of sight environments. This is illustrated in more detail by means of FIGS. 3 and 4. Although FIGS. 3 and 4 relate to r₁ only, it will be apparent to those skilled in the art that the illustrated effect is also valid for r₂. It is assumed that signals s₁ and s₂ are QPSK encoded according to constellations 30 and 31. Since the QPSK constellations encode bit streams d₁, d2 using 4 possible symbols, it will be apparent that r₁ can assume up to 16 symbols. The example of FIG. 3 corresponds to a rich scattering environment wherein h₁₁=1 and h₁₂=exp(−jπ/4). Therefore, r1 equals ₁=s₁+exp(−jπ/4).s₂. Due to h₁₂, signals transmitted from antenna 9 to antenna 16 will undergo a forty-five degrees phase shift to provide the required orthogonality between transmitted signals s₁ and s₂. Assuming QPSK modulation of s₁ and s₂, receiver Rₓ₁ may detect any of the 16 symbols as shown in (the rotated 16-QAM) constellation 30 of FIG. 3.

FIG. 4 corresponds to the worst-case situation e.g. during a line of sight situation, wherein the propagation channels do not provide any phase shift (h₁₁−h₁₂=1). Consequently, r₁ becomes r₁=s₁+S₂. Again, assuming QPSK modulation for s₁ and s₂, r1 can assume any of the symbols that are shown in FIG. 40. Due to the behavior of the communication channels, some of symbols of FIG. 40 are overlapping points (open circles) such that the receiver will only be able to detect four out of 16 symbols without error. The overlapping of symbols can easily be illustrated by means of the following example: r₁ equals zero, not only for s₁=1+j and s₂=−1−j but also for s₁=−1−j and s₂=1+j. According to the present invention, the deficit of the communication channel can be easily overcome by precoding at least one of the transmitted signals. This precoding can for example be achieved by rotating at least one of the constellations since, from a system point of view it does not matter whether the orthogonality is provided by the channel or by the mapping process. This is for example illustrated in FIG. 5 wherein constellation 50 is rotated by 45 degrees. Basically this correspond to multiplying the mapped symbols of s₂ with exp(−jπ/4) so that r₁ equals r₁=h₁₁.s₁+h₁₂.exp(−jπ/4).s₂. Letting h₁₁=h₁₂=1 reduces the equation to equals r₁=s₁+exp(−jπ/4).s₂ which corresponds to the example as shown in FIG. 3. Although the examples given relate to a 2×2 system, it will be apparent to those skilled in the art that the invention can be easily extended to larger N×M systems. Clearly, the invention requires synchronization between the transmitter and receiver, since only the receiver can detect the level of correlation between the received signals r₁ and r₂ whilst only the transmitter is able to rotate a modulation constellation. Depending on the telecommunication system, the initiative to rotate the constellation can come from either side. It is for example feasible that the receiver instructs the transmitter to rotate the constellation after detecting an unacceptable level of correlation or it can merely transmit a quality indicator to the transmitter such as a Bit Error Rate where upon the transmitter may autonomously decide to rotate the constellation. An instruction from receiver to the transmitter may for example include a command to increment or decrement the angle with a certain step size or it may comprise an instruction to rotate through a certain (given) angle. Likewise, the transmitter must inform or acknowledge the receiver about the (imminent) rotation. For example, by acknowledging receipt of a received message in kind of a handshake protocol or by informing the receiver about the imminent change of the constellation. It will be apparent to those skilled in the art that various suitable protocol's between transmitter and receiver can be devised depending on the requirements and or possibilities of the system. The messages between transmitters and receivers can be exchanged using a suitable but arbitrary technique. For example, by embedding the messages in already existing protocols between transmitters and receivers or by establishing dedicated communication links between transmitters and receivers.

Another option for precoding is to reduce the order of the modulation constellations of s₁ and s₂ for example, from QPSK to BPSK. A BPSK constellation as shown in FIG. 6 has values +1 and −1 for mapping binary 0 and 1. Assuming the same relation for r₁ i.e. r₁=s₁+s₂, it will be apparent that from the four possible symbols of r₁, two symbols overlap. However, the chance of detecting a correct symbol is still 50% whilst with QPSK only four out of sixteen possible symbols values (25%) can correctly be detected. Reducing the order therefore enables an easier detection of the symbols. Reducing the order of higher order constellations increases the coverage of the telecommunication system because lower order modulations generally require a lower Signal to Noise ratio In addition, reducing the of the order of the constellations results in a reduced data-throughput of the telecommunication system. Therefore, according to the present invention, it is possible to transmit the data over more than two antennas if required, in order to increase or maintain the achievable throughput of the MIMO system. A possible implementation is shown in FIG. 7. In FIG. 7, multiplexer 73 precedes the transmitters Tx₁ to Txₙ and the receivers are succeeded by demultiplexer 74. This way a data stream 75 can be conveniently mapped into sub streams x₁ to xₙ. Each one of those x₁ to xₙ sub streams are subsequently transmitted through transmitters Tx₁ to Txₙ and received by receivers Rx₁ to Rxₙ. There, they are demapped into sub streams y₁ to yₙ and multiplexed back into a single data stream 76 by means of multiplexer 74. Evidently, by means of multiplexer 73, the data stream 75 can be conveniently split up into as many data streams as necessary required.

It is to be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Transmitter (Tx₁, Tx₂) for simultaneously transmitting at least a first (s′₁) and a second (s′₂) signal, the first signal (s′₁) being modulated according to a first modulation constellation, the second signal (s′₂) being modulated according to a second modulation constellation, wherein the transmitter is arranged to pre-code at least the first signal (s′₁) through a modification of the first modulation constellation so as to prevent a correlation between the at least first (s′₁) and second (S′₂) simultaneously transmitted signals.

2. Transmitter (Tx₁, Tx₂) according to claim 1, wherein the pre-coding of at least the first signal (s′₁) comprises a rotation of the first modulation constellation through a first angle.

3. Transmitter (Tx₁, Tx₂) according to claim 1, wherein the pre-coding of at least the first signal (s′₁) comprises a change of the order of the first modulation constellation.

4. Transmitter (Tx₁, Tx₂) according to claim 3, wherein the pre-coding further comprises a change of the number of simultaneously transmitted signals (s′₁, s′₂).

5. Transmitter (Tx₁, Tx₂) according to claim 1, wherein the transmitter is arranged to pre-code at least the first (s′₁) signal after receipt of a first signal from a receiver (Rx₁, Rx₂) of the at least first (s′₁) and second (s′₂) simultaneously transmitted signals.

6. Transmitter (Tx₁, Tx₂) according to claim 1, wherein the transmitter is arranged to transmit a second signal to a receiver (Rx₁, Rx₂) of the at least first (s′₁) and second signals (s′₂) in order to notify the receiver about the pre-coding of at least the first (s′₁) signal.

7. Transmitter (Tx₁, Tx₂) according to claim 1, wherein the first and second modulation constellations are M-ary QAM modulation constellations.

8. Receiver (Rx₁, Rx₂) for simultaneously receiving at least a first (s′₁) and a second (s′₂) signal from a transmitter (Tx₁, Tx₂), the first received signal (s′₁) being modulated according to a first modulation constellation, the second received signal (s′₂) being modulated according to a second modulation constellation, in which at least the first received signal (s′₁) is pre-coded through a modification of the first modulation constellation so a to prevent a correlation between the at least first (s′₁) and second (s′₂) simultaneously received signals.

9. Receiver (Rx₁, Rx₂) according to claim 8, wherein the pre-coding of the first (s′₁ ) received signal comprises a rotation of the first modulation constellation.

10. Receiver (Rx₁, Rx₂) according to claim 8, wherein the pre-coding of the first (s′₁) received signal comprises a change of the order of the first modulation constellation.

11. Receiver (Rx₁, Rx₂) according to claim 8, wherein the pre-coding further comprises a change of the number of simultaneously received signals (s′₁, s′₂)

12. Receiver (Rx₁, Rx₂) according to claim 8, wherein the receiver is arranged to transmit a first signal to the transmitter in a response to which the transmitter is arranged to pre-code at least the first (s′₁) signal.

13. Receiver (Rx₁, Rx₂) according to claim 8, wherein the receiver is arranged to receive a second signal from the transmitter (Tx₁, Tx₂) in a response to the transmitter pre-coding at least the first (s′₁) signal.

14. Receiver (Rx₁, Rx₂) according to claim 8, wherein the first and second modulation constellations are M-ary QAM modulation constellations.

15. Transceiver comprising a transmitter according to claim 1.

16. Transceiver according to claim 15, further comprising a receiver (Rx₁, Rx₂) for simultaneously receiving at least a first (s′₁) and a second (s′₂) signal from a transmitter (Tx₁, Tx₂), the first received signal (s′₁) being modulated according to a first modulation constellation, the second received signal (s′₂) being modulated according to a second modulation constellation, in which at least the first received signal (s′₁) is pre-coded through a modification of the first modulation constellation so a to prevent a correlation between the at least first (s′₁) and second (s′₂) simultaneously received signals.

17. Wireless device comprising a transmitter according to claim 1.

18. Telecommunication system comprising a transmitter according to claim 1.
